(19) United States
(12) Patent Application Publication
(10) Pub. No.: US 2010/0241499 A1
(43) Pub. Date: Sep. 23, 2010

(54) Moneymail

(76) Inventors: Salvatore Crispo, Vaughan (CA); Luca M. Ciciarelli, (US)

Correspondence Address: MONEYMAIL LTD., 429 WILSON AVENUE SUITE 119, TORONTO, ON, M3H 1TS, CA

(21) Appl. No.: 12/316,196

(22) Filed: Mar. 23, 2009

(51) Int. Cl. G06Q 30/00; G06Q 90/00

(52) U.S. Cl. 705/14.11

(57) ABSTRACT

This patent refers to a $MoneyMail™ System Email Service Provider, Database Development, Social Networking Applications and Direct Marketing Engine. The $MoneyMail™ system amalgamates two Prior Arts, email service provider (ESP) and direct email marketing service. The $MoneyMail™ users are generously compensated for receiving and viewing admail. The $MoneyMail™ system ensures that all advertisers admail will successfully reach the user, whereas, other ESPs have many SPAM blocking systems in place that cause mail to be ‘bounced’. The users that receive admail are selected from a comprehensive database dependant upon the advertisers' search criteria. The $MoneyMail™ system compensates users only upon opening and viewing the admail. The advertiser will be refunded for any admail that goes unviewed for a specified period of time.

The present invention may have one or more of the following advantages:

The $MoneyMail™ System amalgamates two Prior Arts, email service provider (ESP) and direct email marketing service. There are several advantages to this system. They are as follows:

1. The fact that it actually merges these two components;

2. The user is generously compensated for receiving and viewing admail ($MoneyMail™);

3. There are many SPAM blocking systems in place that cause mail to be ‘bounced’. Since the $MoneyMail™ System may completely control all email or operate as an accepted social networking application (i.e. Facebook), it ensures that all advertisers admail will successfully reach the user;

4. The $MoneyMail™ System compensates users only upon opening and viewing the admail. Any unopened admail, after a specified period of time, will result in a refund to the advertiser;

5. Sender is limited, on initial contact, to sending one email per user to greatly reduce SPAM under the ESP system only;

6. The system may subsequently be licensed to other ESPs, Online Social Networks or other entities for the purpose of incorporating $MoneyMail™ into their user email database.

### DRAWINGS—FIGURES

FIGURE 1.—Flowchart System Summary (Revised)

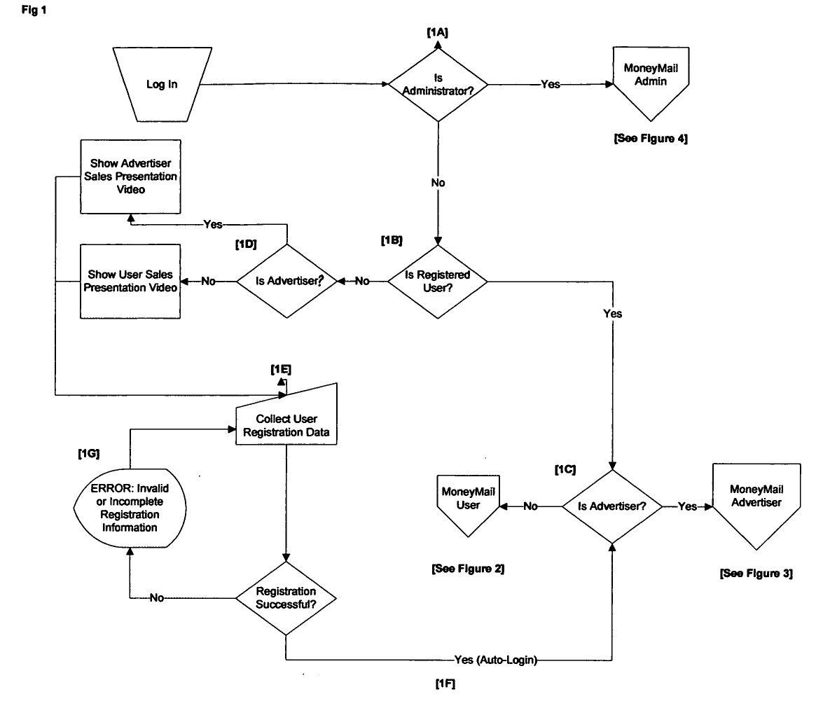

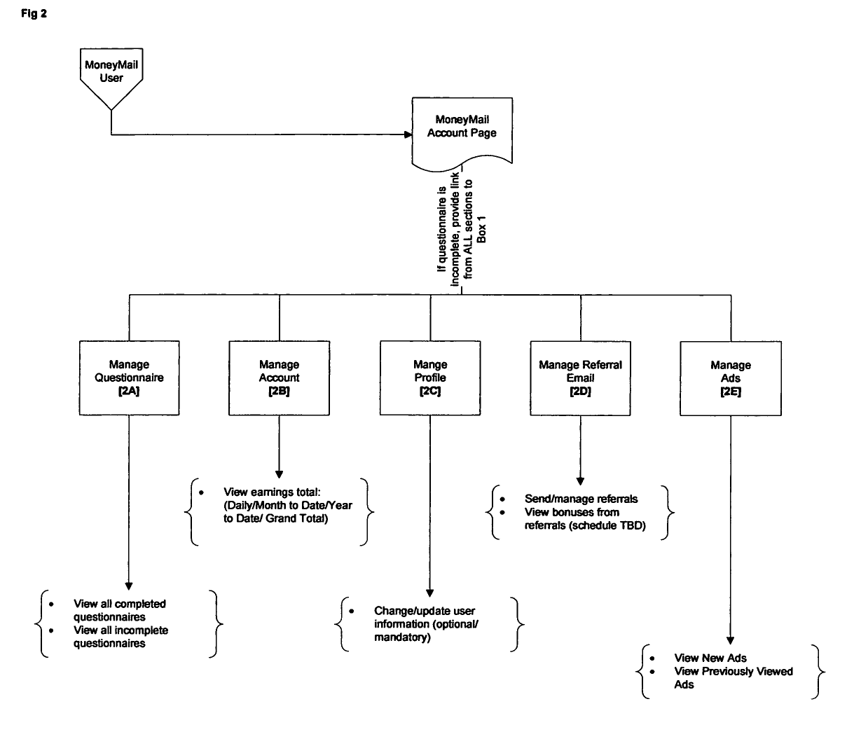

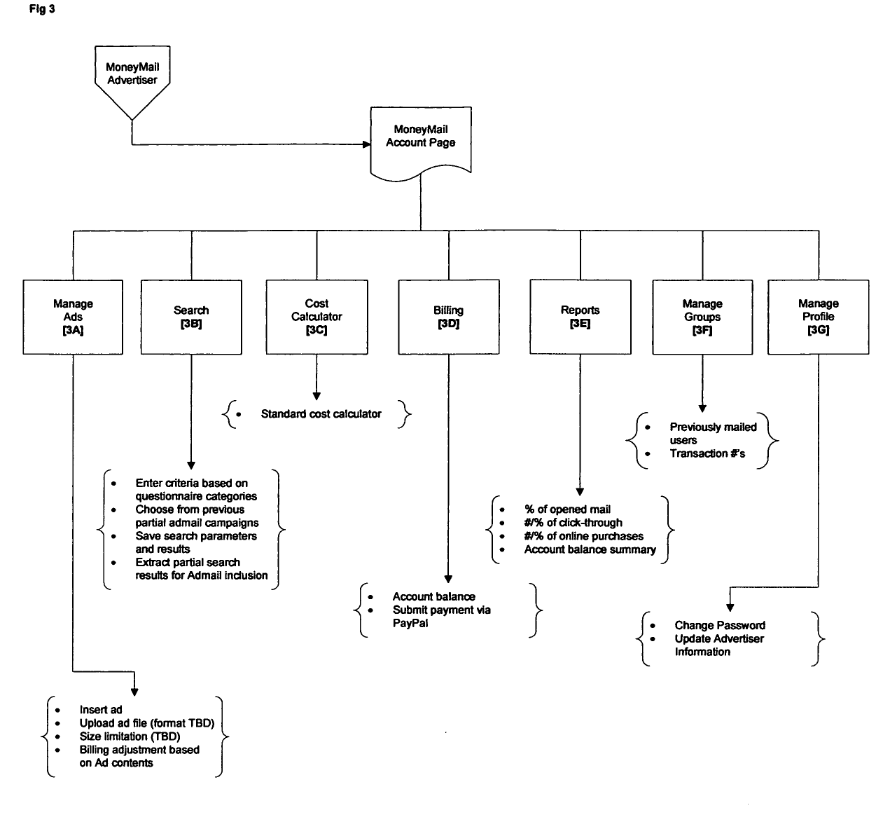

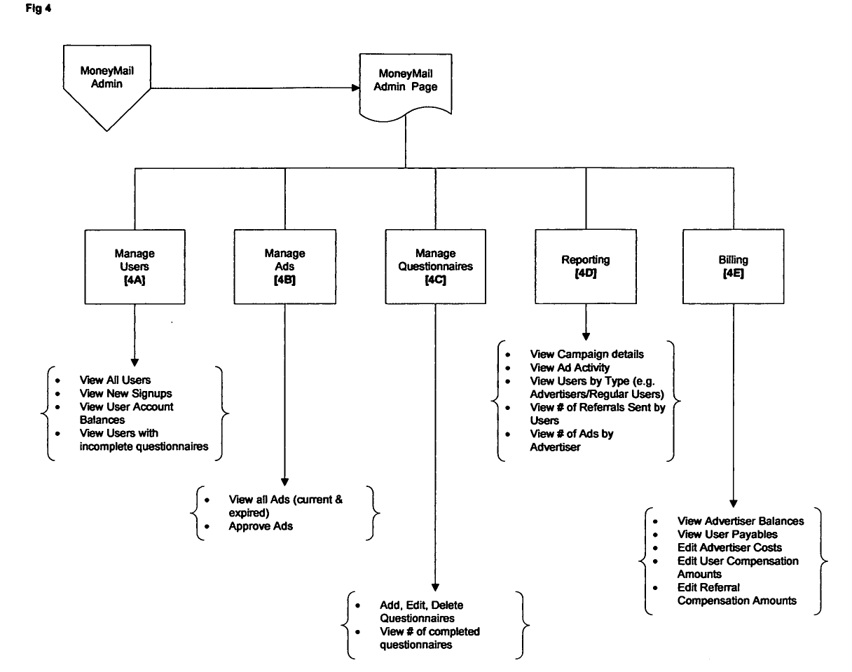

### DRAWINGS—REFERENCE NUMERALS

1.Flowchart—is self-explanatory

### Description

This is a system comprised of three components; one part provides free email service to users in order to collect data for the second component. The second section is geared toward advertisers for the purpose of direct email target marketing. The third is an administrative component to be used only by the system operators.

### Operation

Please see attached $MoneyMail™ System outline for details.

### Alternative Embodiments

The system may subsequently be licensed, under the terms and conditions of an End User License Agreement, to other ESPs, Online Social Networks or other entities for the purpose of incorporating $MoneyMail™ into their user email database. The other ESPs benefit from earning a portion of the admail proceeds.

1. We are patenting a working system, comprised of existing technologies, yet creating a unique invention where the user of the system is remunerated for the viewing of advertising in an online electronic mail format while the advertiser is offered a guarantee that they are responsible for the payment of viewed advertising only.
